(19) United States
(12) Patent Application Publication
(10) Pub. No.: US 2025/0178341 A1
(43) Pub. Date: Jun. 5, 2025

(54) HEAD SYSTEM AND PRINTER

(71) Applicant: BROTHER KOGYO KABUSHIKI KAISHA, Nagoya (JP)

(72) Inventors: Yuji KOGAME, Nagoya (JP); Yasuhiro SHIMAMURA, Nagoya (JP)

(73) Assignee: BROTHER KOGYO KABUSHIKI KAISHA, Nagoya (JP)

(21) Appl. No.: 18/956,838

(22) Filed: Nov. 22, 2024

(30) Foreign Application Priority Data
Nov. 30, 2023 (JP) 2023-203163

(51) Int. Cl. B41J 2/045

(52) U.S. Cl. CPC B41J 2/0455; B41J 2/04508; B41J 2/04573; B41J 2/04586

(57) ABSTRACT

A head system includes: a controller; heads; and head modules connected in series via communication cables and configured to transfer printing data, transmitted by the controller. Each of the head modules is connected to one of the heads and includes a memory and a switch configured to switch destination of connection of an upstream communication cable of each of the head modules. In a case where one head module receives printing data to be processed by the one head module, the switch of the one head module connects an upstream communication cable of the one head module to the memory thereof. In a case where the one head module receives printing data to be processed by a head module which is downstream of the one head module, the switch of the one head module connects the upstream communication cable to a downstream communication cable of the one head module.

### REFERENCE TO RELATED APPLICATIONS

This application claims priority from Japanese Patent Application No. 2023-203163 filed on Nov. 30, 2023. The entire content of the priority application is incorporated herein by reference.

### BACKGROUND ART

A known liquid ejection control apparatus includes head control parts each controlling ejection of one of ejecting parts included in a liquid ejecting head. The head control parts are connected in a daisy chain (connected in series). Each of the head control parts performs control so that liquid droplets are ejected from one of the ejecting parts in accordance with image data.

### SUMMARY

Among the head control parts (head modules) connected in series, a certain head control part (a head module on the upstream side), connected to a location close to a controller which transmits the image data (printing data), temporarily stores printing data to be processed by a head control part (a head module on the downstream side) connected to a location far from the controller, in addition to printing data to be processed by the certain head control part, and then the certain head control part transfers the printing data to be processed by the head control part on the downstream side. Therefore, this takes a long time since the controller has transmitted the printing data until the head control part on the downstream side receives the printing data.

The present disclosure has been made in view of the above-described circumstances, and an object of the present disclosure is to provide a head system capable of quickly transmitting the printing data to the head module connected to the location far from the controller and to provide a printer including the head system.

A head system according to an embodiment of the present disclosure includes: a controller; a plurality of heads; and a plurality of head modules connected to the controller in series via communication cables and configured to transfer printing data transmitted by the controller sequentially. Each of the head modules is connected to one of the heads and includes a memory and a switch. The switch is connected to the memory and a downstream communication cable of each of the head modules. The switch is configured to switch destination of connection of an upstream communication cable of each of the head modules. In a case where one head module included in the head modules receives printing data to be processed by the one head module from an upstream head module which is included in the head modules and is nearer to the controller than the one head module, the switch of the one head module is configured to connect an upstream communication cable of the one head module to the memory of the one head module and disconnect the upstream communication cable of the one head module from a downstream communication cable of the one head module. In a case where the one head module receives printing data to be processed by a downstream head module which is included in the head modules and is farther from the controller than the one head module, from the upstream head module, the switch of the one head module is configured to connect the upstream communication cable of the one head module to the downstream communication cable of the one head module and disconnect the upstream communication cable of the one head module from the memory of the one head module. Further, a printer according to an embodiment of the present disclosure includes the head system as described above.

In the head system according to the embodiment of the present disclosure and a printer including the head system, the printing data can be transmitted quickly to the head module connected to a location far from the controller.

### BRIEF DESCRIPTION OF DRAWINGS

FIG. 1 is a schematic plan view of a printer.

FIG. 2 is a block diagram of a control unit and an ink-jet head.

FIG. 3 is a block diagram of a head module.

FIG. 4 is a diagram illustrating printing data.

FIG. 5 is a flowchart indicating a process by a control part of a controller.

FIG. 6 is a flowchart indicating a process by a control part of the head module.

FIG. 7 is a diagram illustrating printing data according to a second embodiment.

FIG. 8 is a flowchart indicating a process by a control part of a controller according to the second embodiment.

FIG. 9 is a flowchart indicating a process by a control part of a head module according to the second embodiment.

FIG. 10 is a block diagram of a head module according to a third embodiment.

FIG. 11 is a diagram illustrating printing data according to the third embodiment.

FIG. 12 is a flowchart indicating an example of a process of a switch controlling circuit of a switch according to the third embodiment.

FIG. 13 is a diagram illustrating printing data according to a fourth embodiment.

FIG. 14 is a flowchart indicating a process by a control part of a controller according to the fourth embodiment.

FIG. 15 is a flowchart indicating an example of a process of a switch controlling circuit according to the fourth embodiment.

FIG. 16 is a block diagram of a control unit and an ink-jet head according to a fifth embodiment.

FIG. 17 is a block diagram of a head module and a non-switch head module according to the fifth embodiment.

FIG. 18 is a block diagram of a control unit and an ink-jet head according to a sixth embodiment.

FIG. 19 is a block diagram of a head module and a non-memory head module according to the sixth embodiment.

FIG. 20 is a block diagram of a control unit and an ink-jet head according to a seventh embodiment.

FIG. 21 is a block diagram of a head module and a sub-head module according to the seventh embodiment.

FIG. 22 is a block diagram of a head module according to an eighth embodiment.

### DESCRIPTION

### First Embodiment

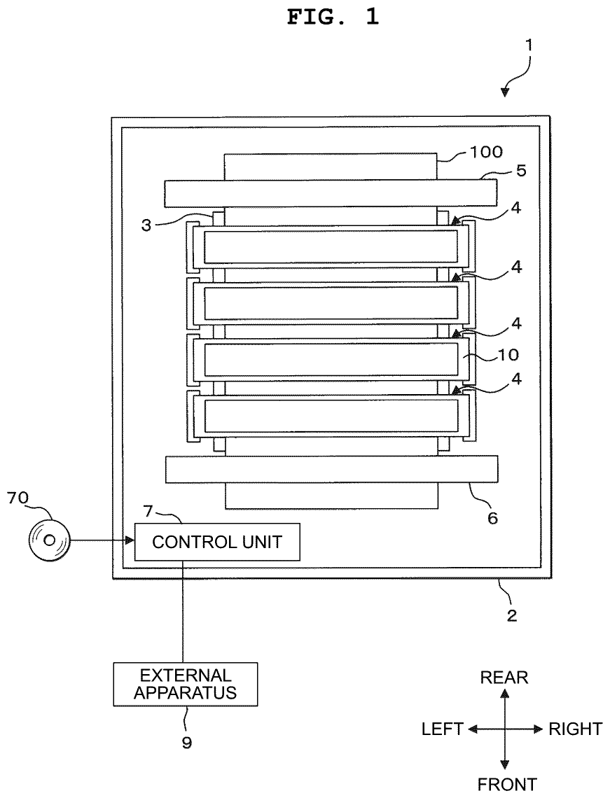

The present disclosure will be described below based on the drawings depicting a printer according to the first embodiment. FIG. 1 is a schematic plan view of a printer 1. In FIG. 1, the conveying direction of a recording sheet 100 corresponds to the front-rear direction of the printer 1. Further, the width direction of the recording sheet 100 corresponds to the left-right direction of the printer 1. Furthermore, the direction orthogonal to the front-rear direction and the left-right direction, i.e., the direction perpendicular to the sheet surface of FIG. 1, corresponds to the up-down direction of the printer 1.

As depicted in FIG. 1, the printer 1 includes a case 2, and a platen 3, four ink-jet heads 4, two conveying rollers 5 and 6, a control unit 7, etc., which are accommodated in the casing 2. The printer 1 corresponds to a “liquid ejecting apparatus”, and the conveying rollers 5 and 6 correspond to a “conveyor”.

The recording sheet 100 passes over the upper surface of the platen 3. Four ink-jet heads 4 are disposed side by side in the conveying direction and above the platen 3. Each of the four ink-jet heads 4 is a so-called head of the line type. Ink is supplied to each of the four ink-jet heads 4 from an ink tank (not depicted in the drawings). Inks of different colors are supplied, respectively, to the four ink-jet heads 4.

As depicted in FIG. 1, the two conveying rollers 5 and 6 are disposed on the rear and front sides, respectively, of the platen 3. The two conveying rollers 5 and 6 are each driven by a non-illustrated motor, and convey the recording sheet 100 on the platen 3 forward. The control unit 7 is connected to an external apparatus 9 such as a PC so as to be able to perform data communication with the external apparatus 9, and controls the respective parts of the printer 1, based on print data transmitted from the external apparatus 9.

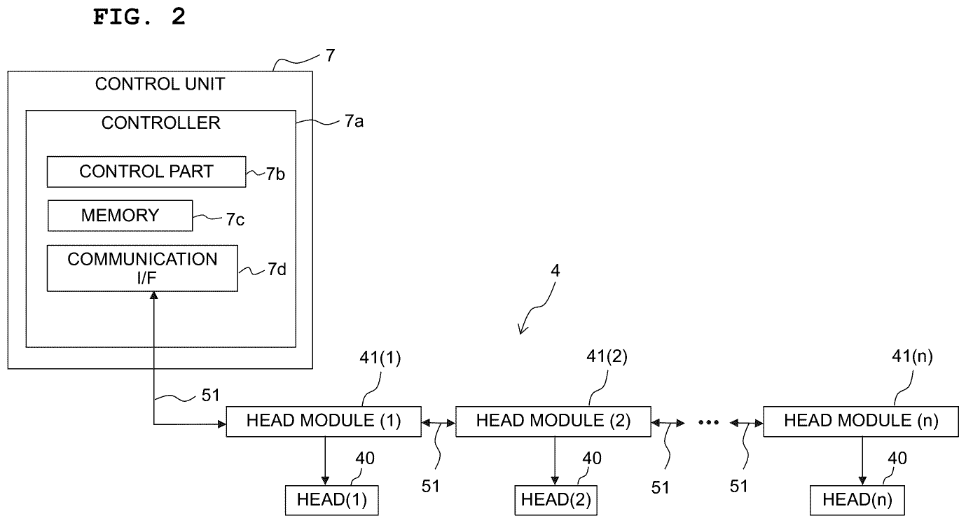

FIG. 2 is a block diagram of the control unit 7 and an ink-jet head 4 of the four ink-jet heads 4. The control unit 7 and the ink-jet heads 4 construct a head system. The control unit 7 includes a controller 7a. The controller 7a includes a control part 7b, a memory 7c, and a communication interface (I/F) 7d. The control part 7b includes an integrated circuit, such as an FPGA, etc. Note that the control part 7b may include a processor, such as a CPU, or an ASIC, etc. The memory 7c includes a main memory and an auxiliary memory. An example of the main memory is a RAM. An example of the auxiliary memory is a ROM and a rewritable storage medium, such as an EEPROM, a Flash ROM, or a hard disk, etc. A control program is stored in the auxiliary memory. The control part 7b reads the control program from the auxiliary memory to the main memory and executes the control program. The control program may be installed in the auxiliary memory from a recording medium 70 (see FIG. 1), such as an optical disk or a portable flash memory, etc. Note that the control program may be downloaded to the auxiliary memory from a server connected to the printer 1 via a communication network. The communication I/F 7d is connected to one of communication cables 51. The control unit 7 controls the printer 1 based on the control program.

The ink-jet head 4 includes a plurality of head modules 41. The plurality of head modules 41 are disposed side by side, for example, in the left-right direction and are connected in series via the communication cables 51. The plurality of head modules 41 includes, for example, a first head module 41(1), a second head module 41(2), a third head module 41(3), . . . and an nth head module 41(n) (“n” is a natural number). The first head module 41(1) is disposed at the leftmost position and the nth head module 41(n) is disposed at the rightmost position among the plurality of head modules 41. The first head module 41(1) is disposed at the position closest to the control unit 7 among all the plurality of head modules 41, and the nth head module 41(n) is disposed at the farthest position from the control unit 7 among all the plurality of head modules 41.

Note that the left side of FIG. 2 corresponds to the upstream, and the right side of FIG. 2 corresponds to the downstream. The leftmost head module 41(the first head module 41(1)) depicted in FIG. 2 is the upstream-most head module 41, and the rightmost head module 41(the nth head module 41(n)) is the downstream-most head module 41.

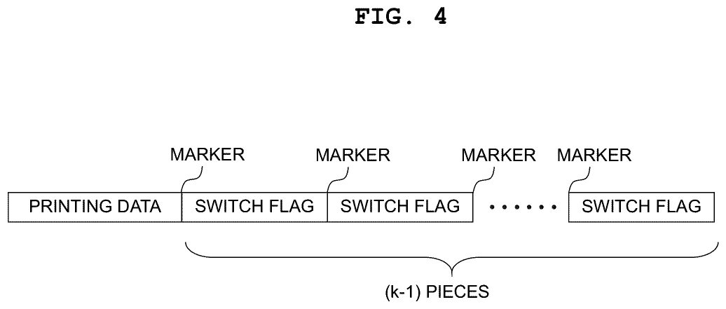

Each of the plurality of head modules 41 is connected to one of the plurality of heads 40. In a case where a head module 41 of the plurality of head modules 41 receives printing data (see FIG. 4) to be processed by the head module 41 itself, the head module 41 drives a head 40, of the plurality of heads 40, which is connected to the head module 41.

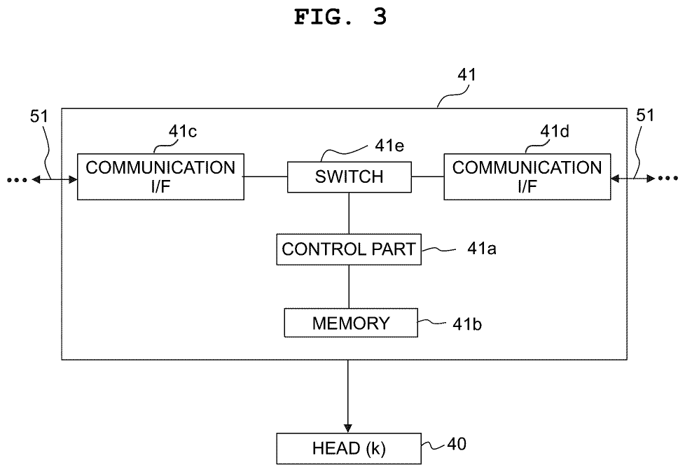

FIG. 3 is a block diagram of a head module 41 of the plurality of head modules 41. The head module 41 includes a control part 41a, a memory 41b, a communication I/F 41c, a communication I/F 41d, and a switch 41e. The control part 41a includes a processor such as a CPU or an MPU, etc. Note that the control part 41a may include an integrated circuit such as an FPGA or an ASIC, etc. The memory 41b includes a volatile memory such as an SDRAM, and a rewritable and non-volatile storage medium such as an EEPROM, a Flash ROM, or a hard disk, etc. Each of the communication I/F 41c and the communication I/F 41d is connected to one of the communication cables 51.

The switch 41e is connected to the communication I/F 41c and the communication I/F 41d. The control part 41a is connected to the switch 41e. The memory 41b is connected to the control part 41a. The switch 41e is switched to a state (first state) that the switch 41e connects a communication cable 51, which is upstream of the head module 41 and connected to the head module 41 via the communication I/F 41c, to the control part 41a and the memory 41b, or to a state (second state) that the switch 41e connects the communication cable 51, which is upstream of the head module 41 and connected to the head module 41 via the communication I/F 41c, to a communication cable 51 which is downstream of the head module 41 and connected to the head module 41 via the communication I/F 41d.

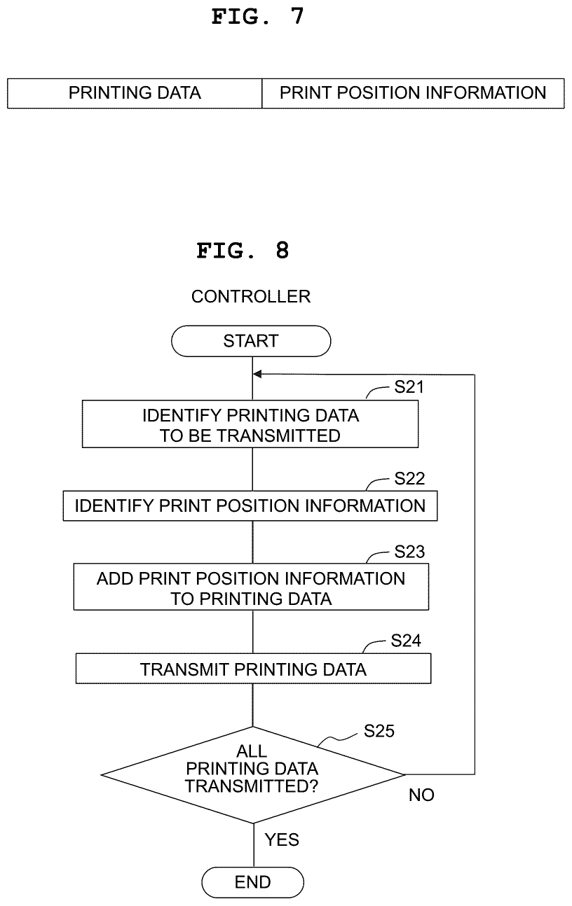

FIG. 4 is a diagram illustrating the printing data. For example, in a case where the controller 7a receives the print data from the external apparatus 9, the controller 7a transmits printing data based on the received print data to the downstream side. In FIG. 4, the right side indicates the head of the data, and the left side indicates the end of the data. This is similarly applied also to FIGS. 7, 11, and 13. Upon transmitting and receiving data, the controller 7a and the head module 41 transmit and receive the data from the head of the data. The printing data is data processed by the head module 41 which has received the printing data so as to drive the head 40. The printing data includes, for example, information on the kind and the amount of the ink to be ejected by the head 40. Upon transmitting the printing data to the downstream side, the controller 7a identifies which of the first head module 41(1) to nth head module 41(n) is a kth head module 41(k) that processes the printing data to be transmitted. The controller 7a adds, to the printing data, a switch flag for switching, to the second state, the switch 41e of each of head modules 41(the first head module 41(1) to the (k-1)th head module 41(k-1)) included in the plurality of head modules 41 and positioned upstream of the identified kth head module 41(k). That is, (k-1) switch flags are added to the printing data. Note that the switch flag may be a flag for switching the switch 41e of the identified kth head module 41(k) to the first state. In this case, one switch flag is added with respect to one printing data. Note that a marker indicating the boundary of data is disposed at the boundary between each of the switch flags and the printing data.

The data received by the head module 41 is stored, for example, in a buffer area disposed in the communication I/F 41c. Among the data stored in the communication I/F 41c, data from the head to the first marker is separated and transmitted to the switch 41e. The switch 41e of the head module 41 is initially in the first state. That is, in a case where the head module 41 receives the printing data and in a case where the switch flags are added to the received printing data, the control part 41a of the head module 41 obtains a foremost switch flag among the switch flags. In a case where the switch flags are not added to the printing data received by the head module 41, the control part 41a obtains the printing data.

In a case where the switch flags are added to the head of the printing data received by the head module 41, the control part 41a of the head module 41 obtains the foremost switch flag. The control part 41a which has obtained the switch flag switches the switch 41e to the second state. As a result, among the data received by the head module 41, the switch flags, other than the foremost switch flag, and printing data which are held in the communication I/F 41c are transferred to the downstream side. That is, the switch flag is information indicating the head module 41 by which the printing data is to be processed, and in a case where the control part 41a obtains the switch flag, the control part 41a determines that the printing data received by the head module 41 is not the printing data to be processed by the head module 41; whereas in a case where the control part 41a does not obtain the switch flag, the control part 41a determines that the printing data received by the head module 41 is the printing data to be processed by the head module 41. The control part 41a switches the switch 41e to the first state after a predetermined amount of time has elapsed since the switch 41e was switched to the second state. As a result, after the transfer of the printing data is completed, the switch 41e is switched to the first state.

In a case where a switch flag is not added to the head of the printing data received by the head module 41, the control part 41a of the head module 41 obtains the printing data. The control part 41a causes the memory 41b to store the obtained printing data, and executes a process of driving the head 40 connected to the head module 41, based on the printing data stored in the memory 41b.

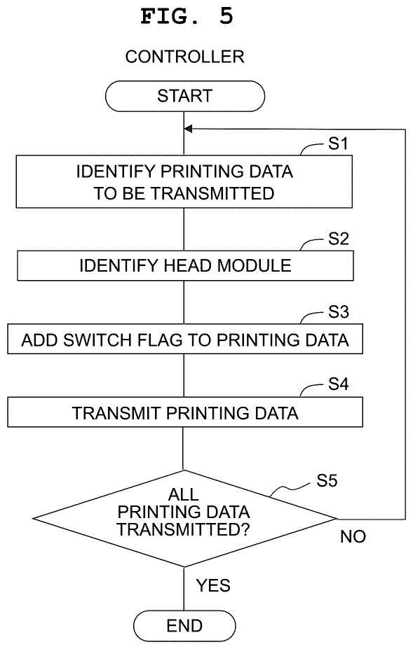

FIG. 5 is a flowchart indicating a process by the control part 7b of the controller 7a. For example, in a case where the control part 7b of the controller 7a receives the print data from the external apparatus 9, the control part 7b starts the following process. The control part 7b identifies printing data to be transmitted based on the print data (step S1). The control part 7b identifies a head module 41, among the plurality of head modules 41, by which the printing data is to be processed (step S2). The identified head module 41 is a kth head module 41(k). The control part 7b adds, to the printing data, a switch flag for switching the switch 41e of each of head modules 41 included in the plurality of head modules 41 and positioned upstream of the kth head module 41(k) to the second state (step S3), and transmits the printing data to the downstream side (step S4). The control part 7b determines whether or not all multiple sets of printing data related to the print data have been transmitted (step S5). In a case where all the multiple sets of printing data have not been transmitted (step S5: NO), the control part 7b returns the process to step S1. In a case where all the multiple sets of printing data have been transmitted (step S5: YES), the control part 7b ends the process.

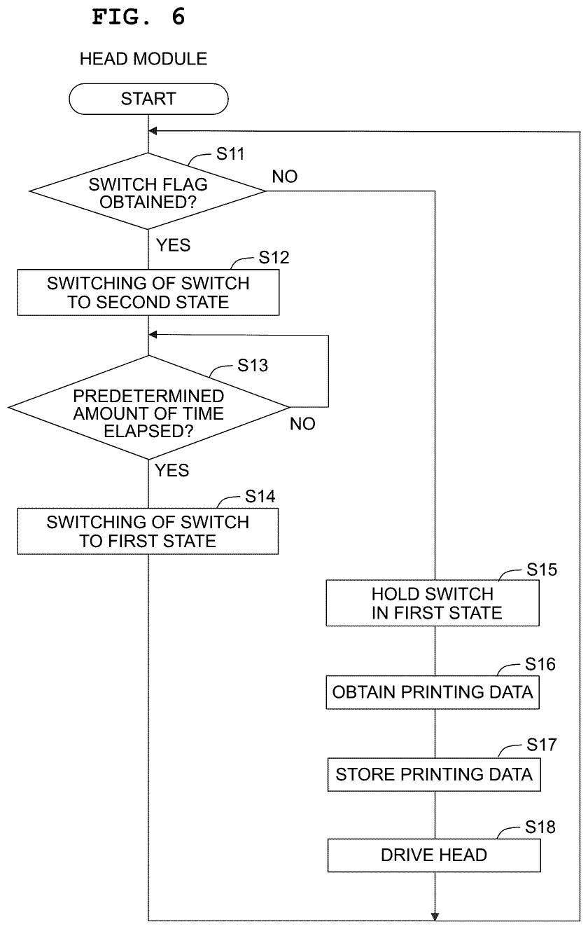

FIG. 6 is a flowchart indicating a process by the control part 41a of the head module 41. The control part 41a of the head module 41 which receives the printing data determines whether or not the control part 41a has obtained the switch flag (step S11). In a case where the control part 41a has obtained a switch flag (step S11: YES), the control part 41a switches the switch 41e to the second state (step S12). The control part 41a determines whether or not a predetermined amount of time has elapsed since the switch 41e was switched to the second state (step S13). In a case where the predetermined amount of time has not elapsed (step S13: NO), the control part 41a returns the process to step S13 and stands by until the predetermined amount of time elapses. In a case where the predetermined amount of time has elapsed (step S13: YES), the control part 41a switches the switch 41e to the first state (step S14) and returns the process to step S11.

In a case where the control part 41a of the head module 41 has not obtained the switch flag (step S11: NO), the control part 41a holds the switch 41e in the first state (step S15) and obtains the printing data (step S16). The control part 41a causes the memory 41 to store the printing data (step S17). The control part 41a drives the head 40 based on the printing data (step S18) and returns the process to step S11.

In the head system according to the first embodiment, in a case where the received printing data is not the printing data to be processed by the head module 41, the switch 41e of the head module 41 which has received the printing data is switched so as to transfer the received printing data to the downstream side, without causing the memory 41b to store the received printing data, based on the switch flag. With this, the printing data can be quickly transmitted to the head module(s) 41 disposed downstream of the head module 41.

### Second Embodiment

A control part 41a of a head module 41 according to the second embodiment obtains the printing data received by the head module 41. Based on information (print position information) indicating a position to which the ink is to be adhered on the recording sheet 100 and added to the printing data obtained by the control part 41a, and based on position information of the head module 41, the control part 41a determines whether or not the printing data received by the head module 41 is the printing data to be processed by the head module 41. In a case where the printing data received by the head module 41 is the printing data to be processed by the head module 41, the control part 41a causes the memory 41b to store the printing data and drives the head 40. In a case where the printing data received by the head module 41 is not the printing data to be processed by the head module 41, the control part 41a switches the switch 41e to the second state and transfers the printing data to the downstream side.

FIG. 7 is a diagram illustrating printing data according to the second embodiment. The controller 7a according to the second embodiment identifies the position to which the ink is to be adhered on the recording sheet 100, based on the printing data to be transmitted to the downstream side. The controller 7a adds, to the head of the printing data, the information (print position information) indicating the position to which the ink is to be adhered on the recording sheet 100, and transmits the data in which the print position information is added to the printing data to the downstream side.

A head module 41, which receives the data in which the print position information is added to the printing data, duplicates the print position information added to the received printing data, for example, in the communication I/F 41c which performs the reception of data. Note that the data received by the head module 41 is held, for example, in the buffer area disposed in the communication I/F 41c, and the duplicated print position information is transmitted to the switch 41e. Since the switch 41e, of the head module 41, is in the first state in the initial state, the control part 41a obtains the duplicated print position information. The control part 41a determines whether or not the received printing data is the printing data to be processed by the head module 41, based on the obtained print position information and based on position information of the head module 41 previously stored in the memory 41b. The position information of the head module 41 previously stored in the memory 41b is information indicating a range in which ink can be adhered on the recording sheet 100 by the ejection of the ink by the head 40 connected to the head module 41. In a case where the received printing data is the printing data to be processed by the head module 41, the control part 41a holds the switch 41e in the first state, and the control part 41a obtains the printing data received by the head module 41. In a case where the received printing data is not the printing data to be processed by the head module 41, the control part 41a switches the switch 41e to the second state. In this situation, the printing data received by the head module 41 is transferred to the downstream side, together with the added print position information.

FIG. 8 is a flowchart indicating a process by the control part 7b of the controller 7a according to the second embodiment. For example, in a case where the control part 7b of the controller 7a receives the print data from the external apparatus 9, the control part 7b starts the following process. The control part 7b identifies the printing data to be transmitted, based on the print data (step S21). The control part 7b identifies the print position information based on the printing data to be transmitted (step S22). The control part 7b adds the identified print position information to the printing data (step S23) and transmits the printing data to the downstream side (step S24). The control part 7b determines whether or not all the multiple sets of printing data related to the print data have been transmitted (step S25). In a case where all the multiple sets of printing data have not been transmitted (step S25: NO), the control part 7b returns the process to step S21. In a case where all the multiple sets of printing data have been transmitted (step S25: YES), the control part 7b ends the process.

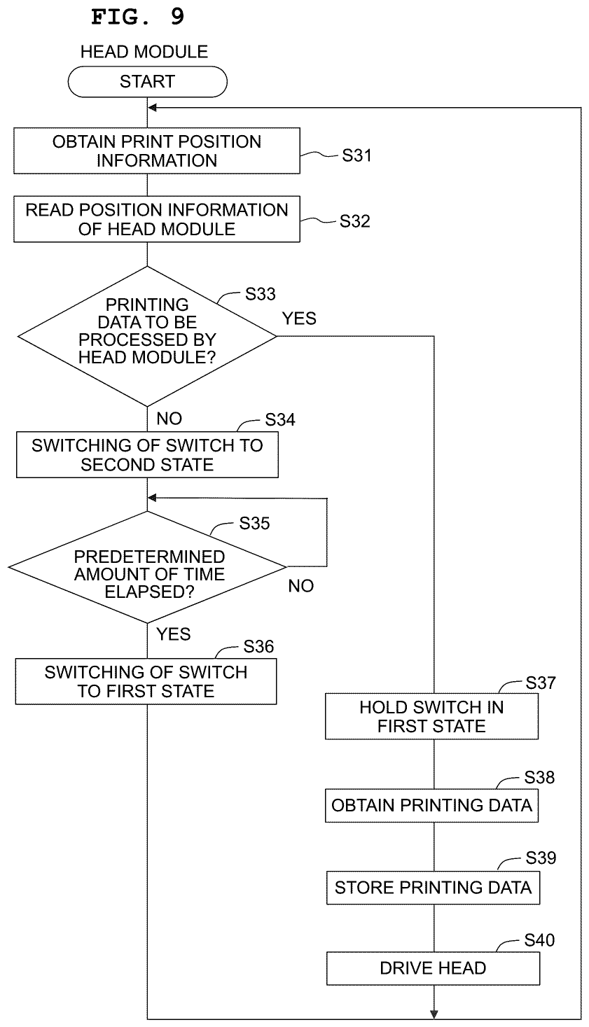

FIG. 9 is a flowchart indicating a process by the control part 41a of the head module 41 according to the second embodiment. The control part 41a of a head module 41 which receives the printing data obtains the print position information (step S31). The control part 41a reads the position information of the head module 41 from the memory 41b (step S32), and determines whether or not the received printing data is the printing data to be processed by the head module 41, based on the print position information and the position information of the head module 41(step S33). In a case where the received printing data is not the printing data to be processed by the head module 41(step S33: NO), the control part 41a switches the switch 41e to the second state (step S34). In a case where the switch 41e is switched to the second state, the print position information and the printing data held in the communication I/F 41c are transmitted to the communication cable 51 on the downstream side via the communication I/F 41d. The control part 41a determines whether or not the predetermined amount of time has elapsed since the switch 41e was switched to the second state (step S35). In a case where the predetermined amount of time has not elapsed (step S35: NO), the control part 41a returns the process to step S35 and stands by until the predetermined amount of time elapses. In a case where the predetermined amount of time has elapsed (step S35: YES), the control part 41a switches the switch 41e to the first state (step S36) and returns the process to step S31.

In a case where the received printing data is printing data to be processed by the head module 41(step S33: YES), the control part 41a of the head module 41 holds the switch 41e in the first state (step S37) and obtains the printing data (step S38). The control part 41a causes the memory 41b to store the printing data (step S39). The control part 41a drives the head 40 based on the printing data (step S40) and returns the process to step S31.

In the head system according to the second embodiment, the control part 41a of the head module 41 determines whether or not the received printing data is the printing data to be processed by the head module 41, based on the print position information and the position information of the head module 41. This allows the controller 7a to transmit the printing data quickly, without having to identify the head module 41 which processes the printing data.

### Third Embodiment

A controller 7a of a head system according to the third embodiment transmits multiple sets of printing data to the downstream side continuously in the order of head modules 41 each of which processes one of the multiple sets of printing data, starting from printing data to be processed by a head module 41 on the upstream side. The data amount of each of the multiple sets of printing data differs depending on the head modules 41 by which the printing data is to be processed. In a case where the switch 41e of a head module 41, of the head modules 41, starts receiving printing data at the head of the continuous multiple sets of printing data, the switch 41e is switched to the first state, and after completing the reception of a predetermined and specified data amount, the switch 41e is switched to the second state.

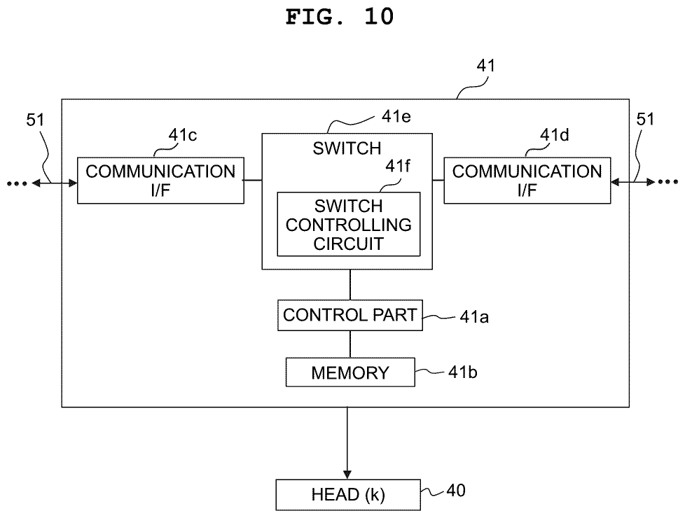

FIG. 10 is a block diagram of a head module 41 according to the third embodiment. A switch 41e of the head module 41 according to the third embodiment includes a switch controlling circuit 41f. The switch controlling circuit 41f includes, for example, an integrated circuit such as an ASIC or FPGA, etc. Note that the switch 41e may include a processor such as a CPU or MPU, etc. In a case where the head module 41 starts receiving the printing data, the switch controlling circuit 41f switches the switch 41e to the first state. The switch controlling circuit 41f measures the data amount received by the head module 41 and transmitted to the control part 41a via the switch 41e which is in the first state. In a case where the head module 41 completes the reception of the predetermined data amount and the control part 41a obtains the predetermined data amount, the switch controlling circuit 41f switches the switch 41e to the second state.

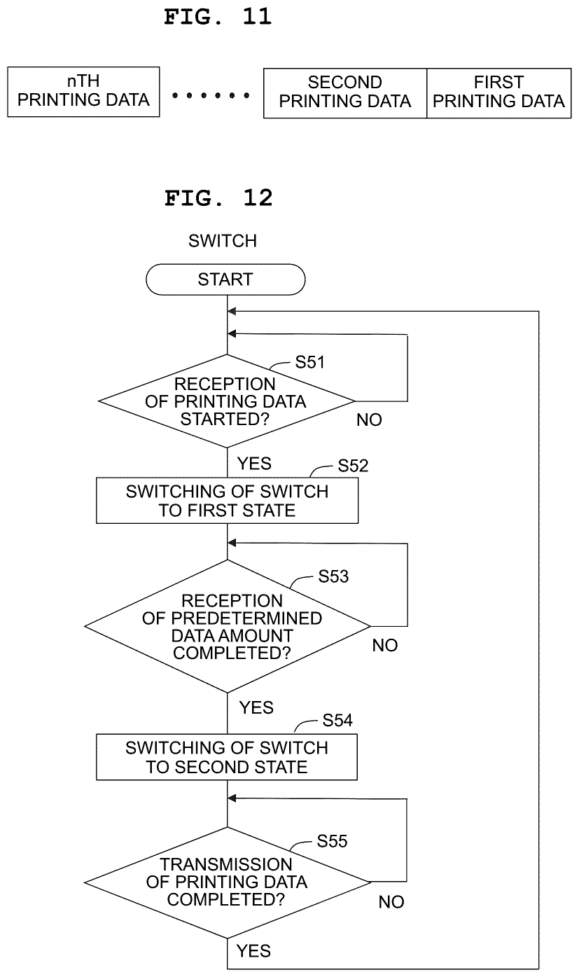

FIG. 11 is a diagram illustrating printing data according to the third embodiment. A controller 7a according to the third embodiment transmits multiple sets of printing data to the downstream side continuously, in the order of printing data (first printing data) to be processed by the first head module 41(1), printing data (second printing data) to be processed by the second head module 41(2), and up to printing data (nth printing data) to be processed by the nth head module 41(n). The data amount of each of the multiple sets of printing data is different, and each of the plurality of head modules 41 stores the data amount of the printing data to be processed by the head module 41 as the predetermined data amount. Each of the plurality of head modules 41 causes the control part 41a to obtain the predetermined data amount from the head of the multiple sets of printing data received by the switch 41e, and transfers the subsequent printing data to the downstream, thereby causing the memory 41b to store only the printing data to be processed by the head module 41.

FIG. 12 is a flowchart indicating an example of a process of the switch controlling circuit 41f of the switch 41e according to the third embodiment. The switch controlling circuit 41f determines whether or not the head module 41 has started the reception of the printing data (step S51). In a case where the head module 41 has not started the reception of the printing data (step S51: NO), the switch controlling circuit 41f returns the process to step S51 and stands by until the head module 41 starts the reception of printing data. In a case where the head module 41 has started the reception of the printing data (step S51: YES), the switch controlling circuit 41f switches the switch 41e to the first state (step S52). Note that in a case where the switch 41e is originally in the first state in step S52, the switch controlling circuit 41f holds the switch 41e in the first state. The switch controlling circuit 41f determines whether or not the head module 41 has completed the reception of the predetermined data amount (step S53). In a case where the head module 41 has not completed the reception of the predetermined data amount (step S53: NO), the switch controlling circuit 41f returns the process to step S53 and stands by until the head module 41 completes the reception of the predetermined data amount. In a case where the head module 41 completes the reception of the predetermined data amount (step S53: YES), the switch controlling circuit 41f switches the switch 41e to the second state (step S54). The switch controlling circuit 41f determines whether or not the head module 41 has completed the transfer, to the downstream side, of the printing data to be processed by a head module 41 other than the head module 41(step S55). Note that the switch controlling circuit 41f determines, in step S55, whether or not the transfer has been completed based on an elapsed time since the switch 41e was switched to the second state or based on the data amount of the printing data transmitted to the communication I/F 41d via the switch 41e. In a case where the transfer has not been completed (step S55: NO), the switch controlling circuit 41f returns the process to step S55 and stands by until the transfer is completed. In a case where the transfer has been completed (step S55: YES), the switch controlling circuit 41f returns the process to step S51.

In the head system according to the third embodiment, the switch 41e is switched based on the data amount received by each of the head modules 41 to thereby cause the memory 41b to store the printing data to be processed by the head module 41, and to transfer, to the downstream side, the other printing data other than the printing data to be processed by the head module 41. Since the controller 7a can transmit the multiple sets of printing data continuously to the downstream side, the multiple sets of printing data can be transmitted quickly.

### Fourth Embodiment

A controller 7a of a head system according to the fourth embodiment adds an error detecting code to the printing data and transmits the printing data. A switch 41e of a head module 41 according to the fourth embodiment includes a switch controlling circuit 41f, similarly to the switch 41e according to the third embodiment. The switch controlling circuit 41f determines whether or not data corruption has occurred in the received printing data and whether or not the received printing data contains an error, based on the error detecting code added to the printing data.

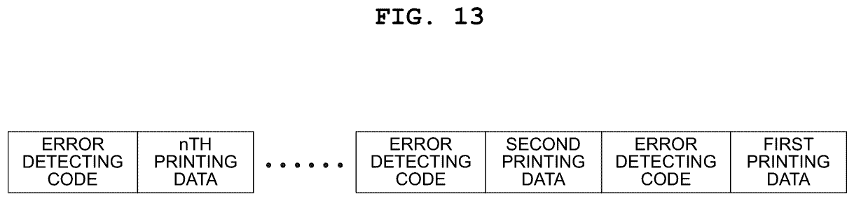

FIG. 13 is a diagram illustrating printing data according to the fourth embodiment. Although the controller 7a according to the fourth embodiment continuously transmits multiple sets of printing data to the downstream side, in a similar manner to the manner in the third embodiment, the controller 7a according to the fourth embodiment adds an error detecting code to the end of each of the multiple sets of printing data. The error detecting code is, for example, a parity bit. With respect to each of the multiple sets of printing data, the controller 7a obtains a distance between the controller 7a and a kth head module 41(k) by which the printing data is to be processed. The distance between the kth head module 41(k) and the controller 7a is determined by the numeric value of the “k”. The controller 7a determines the number of parity bits to be added to the printing data, based on the distance between the controller 7a and the kth head module 41(k) by which the printing data is to be processed. The farther the kth head module 41(k) by which the printing data is to be processed is from the controller 7a, the higher the probability that the data corruption would occur before the printing data reaches the kth head module 41(k). Therefore, the farther the kth head module 41(k) by which the printing data is to be processed is from the controller 7a, the controller 7a increases the number of the parity bits to be added so as to improve the precision of error detection. Specifically, the controller 7a adds, to the printing data, a parity bit of which bit number is a numeric value obtained by dividing the numeric value of the “k” of the kth head module 41(k), by which the printing data is to be processed, by 2 and rounding up to the nearest whole number. In a case where the number of parity bits is “p”, the error detecting code indicates the remainder in a case where the number of bits of which value of “1” in the bit string indicating the printing data transmitted from the controller 7a is divided by 2^{P}.

The switch controlling circuit 41f of the kth head module 41(k) counts the number of bits of which value is “1” included in the data string of the printing data received by the kth head module 41(k). The switch controlling circuit 41f divides the counted number of bits by the number of bit of the error detecting code added to the end of the printing data so as to calculate the remainder. The switch controlling circuit 41f determines whether or not the calculated remainder matches the value indicated by the error detecting code. In a case where the calculated remainder matches the value indicated by the error detecting code, the switch controlling circuit 41f controls the switch 41e in a similar manner to the manner in the third embodiment. In a case where the calculated remainder does not match the value indicated by the error detecting code, the switch controlling circuit 41f transmits, to the controller 7a, information requesting re-transmission of the printing data.

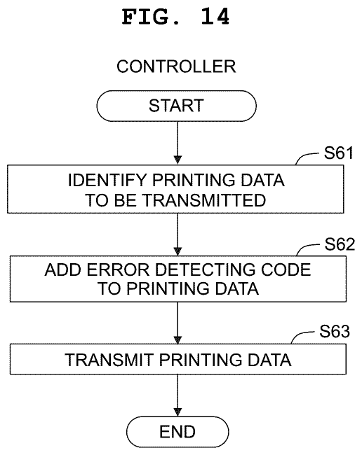

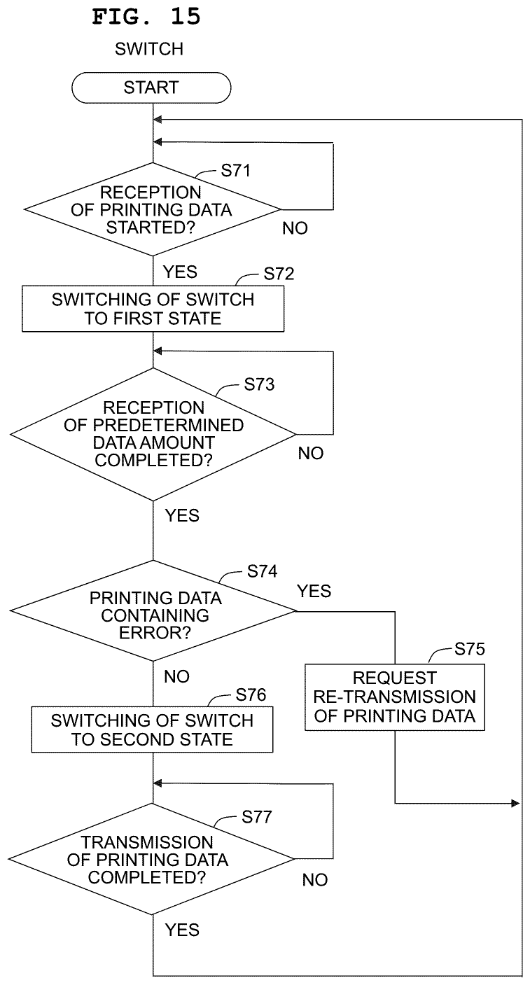

FIG. 14 is a flowchart indicating a process by the control part 7b of the controller 7a according to the fourth embodiment. For example, in a case where the control part 7b of the controller 7a receives the print data from the external apparatus 9, the control part 7b starts the following process. The control part 7b identifies multiple sets of printing data to be transmitted, based on the print data (step S61). The control part 7b adds an error detecting code to the end of each of the multiple sets of printing data, based on each of the multiple sets of printing data to be transmitted (step S62). The control part 7b transmits the multiple sets of printing data each of which has the error detecting code added to the end thereof to the downstream side continuously in the order starting from the printing data processed by the first head module 41(1) (step S63), and ends the process.

FIG. 15 is a flowchart indicating an example of a process of the switch controlling circuit 41f according to the fourth embodiment. The switch controlling circuit 41f determines whether or not the head module 41 has started the reception of the printing data (step S71). In a case where the head module 41 has not started the reception of the printing data (step S71: NO), the switch controlling circuit 41f returns the process to step S71 and stands by until the head module 41 starts the reception of the printing data. In a case where the head module 41 has started the reception of the printing data (step S71: YES), the switch controlling circuit 41f switches the switch 41e to the first state (step S72). Note that in a case where the switch 41e is originally in the first state in step S72, the switch controlling circuit 41f holds the switch 41e in the first state. The switch controlling circuit 41f determines whether or not the head module 41 has completed the reception of a predetermined data amount (step S73). Note that in the present embodiment, in a case where the head module 41 has completed the reception of the predetermined data amount, the head module 41 has received the printing data to be processed by the head module 41 and the error detecting code added to the printing data. In a case where the head module 41 has not completed the reception of the predetermined data amount (step S73: NO), the switch controlling circuit 41f returns the process to step S73 and stands by until the head module 41 completes the reception of the predetermined data amount.

In a case where the head module 41 has completed the reception of the predetermined data amount (step S73: YES), the switch controlling circuit 41f determines whether or not the printing data received by the head module 41 contains an error, based on the error detecting code added to the printing data (step S74). In a case where the printing data contains the error (step S74: YES), the switch controlling circuit 41f transmits, to the controller 7a, the information requesting the re-transmission of the printing data (step S75) and returns the process to step S71. Upon receiving the information requesting the re-transmission of the printing data, the controller 7a re-transmits the printing data to the downstream side. Note that the controller 7a may re-transmit, to the downstream side, only the printing data to be processed by the head module 41 which has transmitted the information requesting the re-transmission of the printing data. In a case where the printing data does not contain the error (step S74: NO), the switch controlling circuit 41f advances the process to step S76. The process related to step S76 to step S77 is similar to the process related to step S54 to step S55 indicated in FIG. 12.

In the head system according to the fourth embodiment, an error occurring due to the data corruption when the printing data is transmitted from the controller 7a to the head module 41 can be detected. Further, by increasing the number of bits of the error detecting code added to the printing data to be processed by the head module 41 which is connected to a location far from the controller 7a, the error contained in the printing data can be efficiently detected.

### Fifth Embodiment

A head system according to the fifth embodiment includes a non-switch head module which does not include a switch 41e. The non-switch head module is connected at least to a part of the plurality of head modules 41 included in the head system, via a second communication cable 52 different from the communication cable (first communication cable) 51.

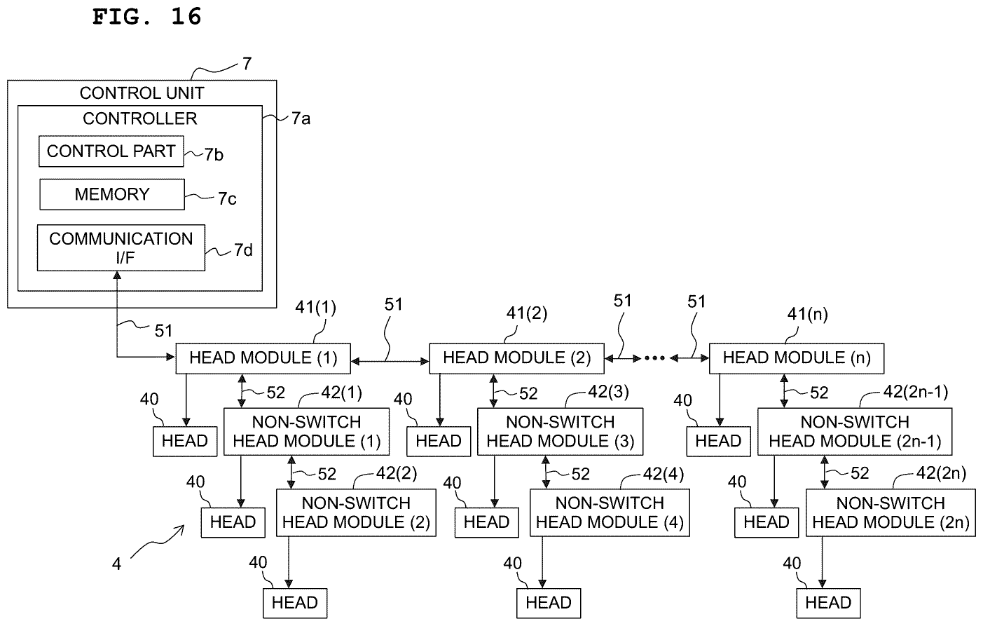

FIG. 16 is a block diagram of a control unit 7 and an ink-jet head 4 according to the fifth embodiment. The ink-jet head 4 according to the fifth embodiment includes non-switch head modules 42. Each of the non-switch head modules 42 is connected to a head module 41 included in the part of the plurality of head modules 41 via a second communication cable 52 different from the first communication cable 51. In the fifth embodiment, two non-switch head modules 42 are disposed side by side in the left-right direction and the two non-switch head modules 42 are connected in series to the downstream side of each of the head modules 41 via the second communication cables 52. A (2k-1)th non-switch head module 42(2k-1) is connected to the downstream side of the kth head module 41(k), and a (2k)th non-switch head module 42(2k) is connected to the downstream side of the (2k-1)th non-switch head module 42(2k-1). Further, a head 40 is connected to each of the non-switch head modules 42.

Note that the non-switch head modules 42 do not need to be connected to the downstream side of all the plurality of head modules 41, and may be connected to the downstream side of a head module 41 included in the part of the plurality of head modules 4. Further, the number of non-switch head modules 42 connected to the downstream side of one head module 41 is not limited to two and may be one, or may be three or more. The number of non-switch head module(s) 42 connected to the downstream side of each of the head modules 41 may be different among the head modules 41.

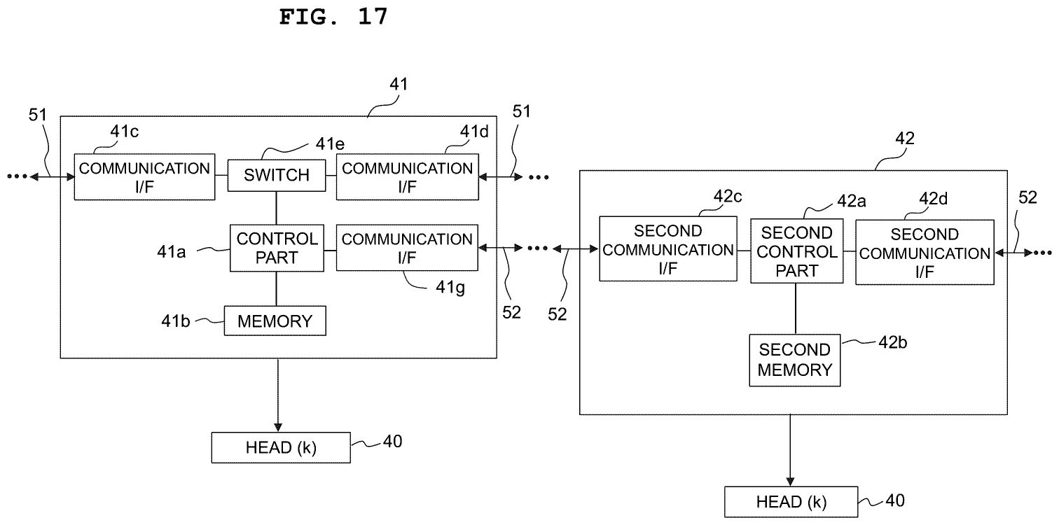

FIG. 17 is a block diagram of the head module 41 and the non-switch head module 42 according to the fifth embodiment. The head module 41 according to the fifth embodiment includes a communication I/F 41g. The communication I/F 41g is connected to the control part 41a of the head module 41 and to the second communication cable 52.

The non-switch head module 42 includes a second control part 42a, a second memory 42b, a second communication I/F 42c, and a second communication I/F 42d. The second control part 42a includes, for example, a processor such as a CPU or an MPU, etc. Note that the second control part 42a may include an integrated circuit such as an FPGA or an ASIC, etc. The second memory 42b includes a volatile memory such as an SDRAM, a rewritable and non-volatile storage medium such as an EEPROM, a Flash ROM, a hard disk, etc. Each of the second communication I/F 42c and the second communication I/F 42d is connected to the second communication cable 52. The second control part 42a is connected to the second communication I/F 42C and the second communication I/F 42d. The second memory 42b is connected to the second control part 42a.

The switch 41e of the kth head module 41(k) according to the fifth embodiment is switched to the first state in a case where the kth head module 41(k) receives the printing data to be processed by the kth head module 41(k), the printing data to be processed by the (2k-1)th non-switch head module 42(2k-1), or the printing data to be processed by the (2k)th non-switch head module 42(2k). In a case where the kth head module 41(k) obtains the printing data, the control part 41a of the kth head module 41(k) causes the memory 41b to store the obtained printing data, and determines whether the obtained printing data is the printing data to be processed by which one of the kth head module 41(k), the (2k-1)th non-switch head module 42(2k-1) and the (2k)th non-switch head module 42(2k). In a case where the obtained printing data is printing data to be processed by the kth head module 41(k), the control part 41a drives the head 40 connected to the kth head module 41(k), based on the printing data. In a case where the obtained printing data is printing data to be processed by either the (2k-1)th non-switch head module 42(2k-1) or the (2k)th non-switch head module 42(2k), the control part 41a transmits the printing data stored in the memory 41b to the downstream side, via the communication I/F 41g and the second communication cable 52.

In a case where the (2k-1)th non-switch head module 42(2k-1) receives the printing data from the kth head module 41(k), the second control part 42a of the (2k-1)th non-switch head module 42(2k-1) obtains the printing data. The second control part 42a causes the second memory 42b to store the obtained printing data, and determines whether the obtained printing data is to be processed by either the (2k-1)th non-switch head module 42(2k-1) or the (2k)th non-switch head module 42(2k). In a case where the obtained printing data is to be processed by the (2k-1)th non-switch head module 42(2k-1), the second control part 42a drives the head 40 connected to the (2k-1)th non-switch head module 42(2k-1), based on the printing data stored in the second memory 42b. In a case where the obtained printing data is printing data to be processed by the (2k)th non-switch head module 42(2k), the second control part 42a transmits the printing data stored in the second memory 42b to the downstream side, via the second communication I/F 42d and the second communication cable 52.

In a case where the (2k)th non-switch head module 42(2k) receives the printing data from the (2k-1)th non-switch head module 42(2k-1), the second control part 42a of the (2k)th non-switch head module 42(2k) obtains the printing data. The second control part 42a causes the second memory 42b to store the obtained printing data, and drives a head 40 connected to the (2k)th non-switch head module 42(2k), based on the printing data stored in the second memory 42b.

As described above, the number of the non-switch head module 42 connected to the downstream side of one head module 41 is not limited to two. A non-switch head module 42 having another non-switch head module 42 connected to the downstream side thereof performs a process similar to the process performed by the (2k-1)th non-switch head module 42(2k-1) described above. A non-switch head module 42 having no other non-switch head modules 42 connected to the downstream side thereof performs a process similar to the process performed by the (2k)th non-switch head module 42(2k) described above.

In the head system according to the fifth embodiment, the control part 41a of the kth head module 41(k) obtains the printing data to be processed by the (2k-1)th non-switch head module 42(2k-1) or by the (2k)th non-switch head module 42(2k). The control part 41a of the kth head module 41(k) transmits the printing data to the downstream side, via the second communication cable 52 different from the communication cable 51 connecting the kth head module 41(k) and the (k+1)th head module 41(k+1). With this, during the time since the kth head module 41(k) has transmitted the printing data to the (2k-1)th non-switch head module 42(2k-1) or the (2k)th non-switch head module 42(2k) and until the (2k-1)th non-switch head module 42(2k-1) or the (2k)th non-switch head module 42(2k) receives the printing data, for example, each of the head modules 41 can transfer the printing data to the downstream side. As a result, the printing data is efficiently transmitted to the head module 41 or the non-switch head module 42 disposed on the downstream side.

### Sixth Embodiment

A head system of the sixth embodiment includes a non-memory head module which does not include the switch 41e and the memory 41b. The non-memory head module is connected at least to a part of the plurality of head modules 41 included in the head system, via a second communication cable 52 different from the communication cable (first communication cable) 51.

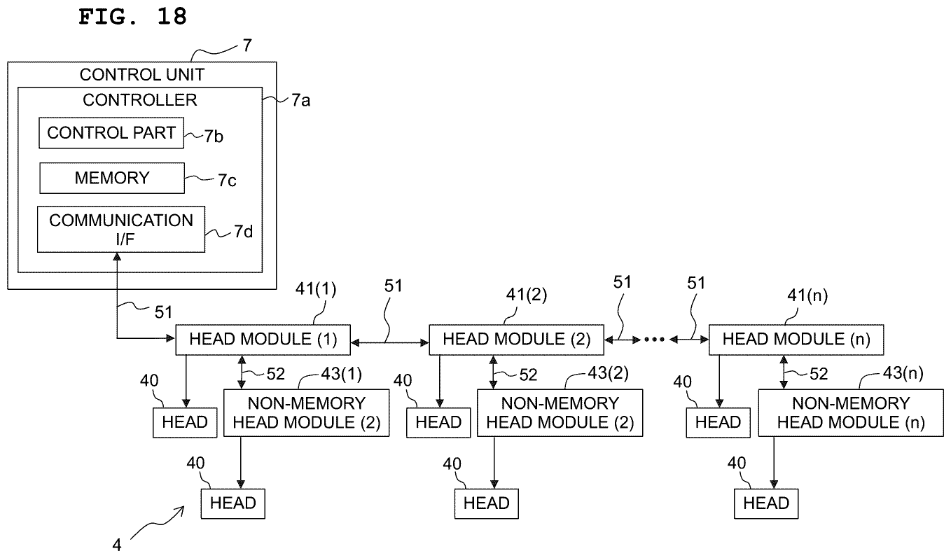

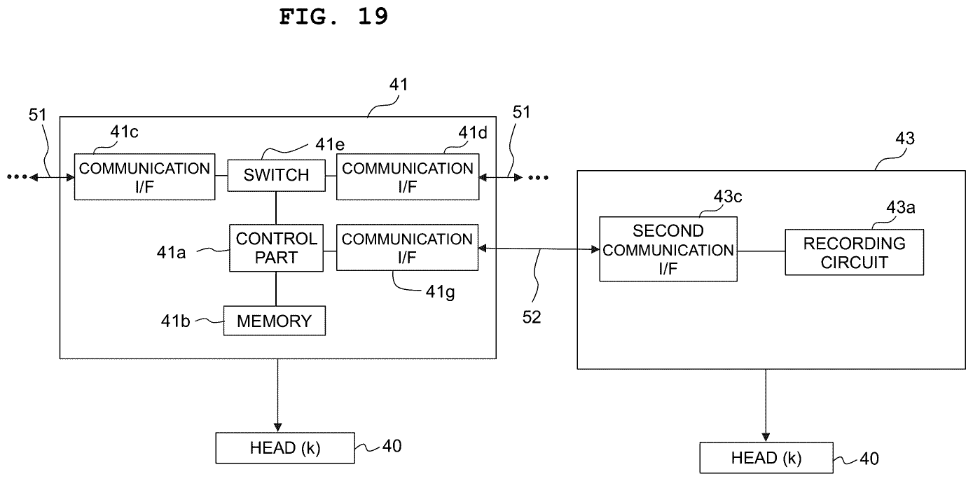

FIG. 18 is a block diagram of a control unit 7 and an ink-jet head 4 according to the sixth embodiment. The ink-jet head 4 according to the sixth embodiment includes non-memory head modules 43. Each of the non-memory head modules 43 is connected to a head module 41 included in the part of the plurality of head modules 41, via the second communication cable 52 different from the first communication cable 51. Although the non-memory head modules 43 according to the sixth embodiment are connected one by one to the downstream side of each of the head modules 41, the non-memory head modules 43 do not need to be connected to the downstream side of all the plurality of head modules 41, and may be connected to the downstream side of the part of the plurality of head modules 41. In the present embodiment, a kth non-memory head module 43(k) is connected to the downstream side of a kth head module 41(k).

FIG. 19 is a block diagram of the head module 41 and the non-memory head module 43 according to the sixth embodiment. The head module 41 according to the sixth embodiment includes a communication I/F 41g. The communication I/F 41g is connected to a control part 41a of the head module 41 and to the second communication cable 52.

The non-memory head module 43 includes a second communication I/F 43c and a recording circuit 43a. The recording circuit 43a includes, for example, an integrated circuit such as an ASIC or FPGA, etc. Note that the recording circuit 43a may include a processor such as a CPU or MPU, etc. One of the heads 40 is connected to each of the non-memory head modules 43.

A switch 41e of the kth head module 41(k) according to the sixth embodiment is switched to the first state in a case where the kth head module 41(k) receives printing data to be processed by the kth head module 41(k) or printing data to be processed by the kth non-memory head module 43(k). In a case where the control part 41a of the kth head module 41(k) obtains printing data, the control part 41a causes the memory 41b to store the obtained printing data and determines whether the obtained printing data is printing data to be processed by either the kth head module 41(k) or the kth non-memory head module 43(k). In a case where the obtained printing data is printing data to be processed by the kth head module 41(k), the control part 41a drives the head 40 connected to the kth head module 41(k) based on the printing data. In a case where the obtained printing data is printing data to be processed by the kth non-memory head module 43(k), the control part 41a transmits the printing data stored in the memory 41b to the downstream side, via the communication I/F 41g and the second communication cable 52.

In a case where the kth non-memory head module 43(k) receives the printing data from the kth head module 41(k), the recording circuit 43a of the kth non-memory head module 43(k) obtains the printing data. The recording circuit 43a drives the head 40 connected to the kth head module 41(k) based on the obtained printing data.

In the head system according to the sixth embodiment, the control part 41a of the kth head module 41(k) obtains printing data to be processed by the kth non-memory head module 43(k). The control part 41a of the kth head module 41(k) transmits the printing data to the downstream side, via the second communication cable 52 different from the communication cable 51 connecting the kth head module 41(k) and the (k+1)th head module 41(k+1). With this, during the time since the kth head module 41(k) has transmitted the printing data to the kth non-memory head module 43(k) and until the kth non-memory head module 43(k) receives the printing data, for example, each of the head modules 41 can transfer the printing data to the downstream side. As a result, the printing data is efficiently transmitted to the downstream side-head module 41 or the kth non-memory head module 43(k).

### Seventh Embodiment

A head system according to the seventh embodiment includes a sub-head module including a second memory and a second switch. The sub-head module is connected to at least a part of the plurality of head modules 41 included in the head system, via a second communication cable 52 different from the communication cable (first communication cable) 51.

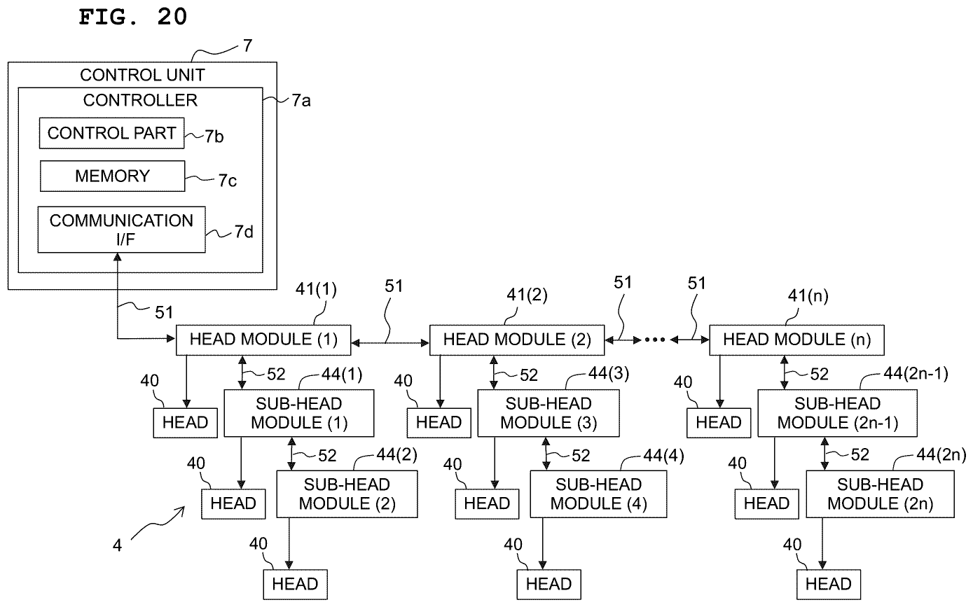

FIG. 20 is a block diagram of a control unit 7 and an ink-jet head 4 according to the seventh embodiment. The ink-jet head 4 according to the seventh embodiment includes sub-head modules 44. Each of the sub-head modules 44 is connected to one of the head modules 41 via the second communication cable 52 different from the first communication cable 51. In the seventh embodiment, two sub-head modules 44 are disposed side by side in the left-right direction and the two sub-head modules 44 are connected in series to the downstream side of each of the head modules 41 via the second communication cables 52. A (2k-1)th sub-head module 44(2k-1) is connected to the downstream side of a kth head module 41(k), and a (2k)th sub-head module 44(2k) is connected to the downstream side of the (2k-1)th sub-head module 44(2k-1). Further, a head 40 is connected to each of the sub-head modules 44.

Note that the sub-head modules 44 do not need to be connected to the downstream side of all the plurality of head modules 41, and may be connected to the downstream side of the part of the plurality of head modules 41. Further, the number of sub-head modules 44 connected to the downstream side of one head module 41 is not limited to two, and may be one, or may be three or more. The number of sub-head module(s) 44 connected to the downstream side of each of the head modules 41 may be different. Furthermore, other sub-head modules 44 may be connected to the downstream side of the sub-head module 44.

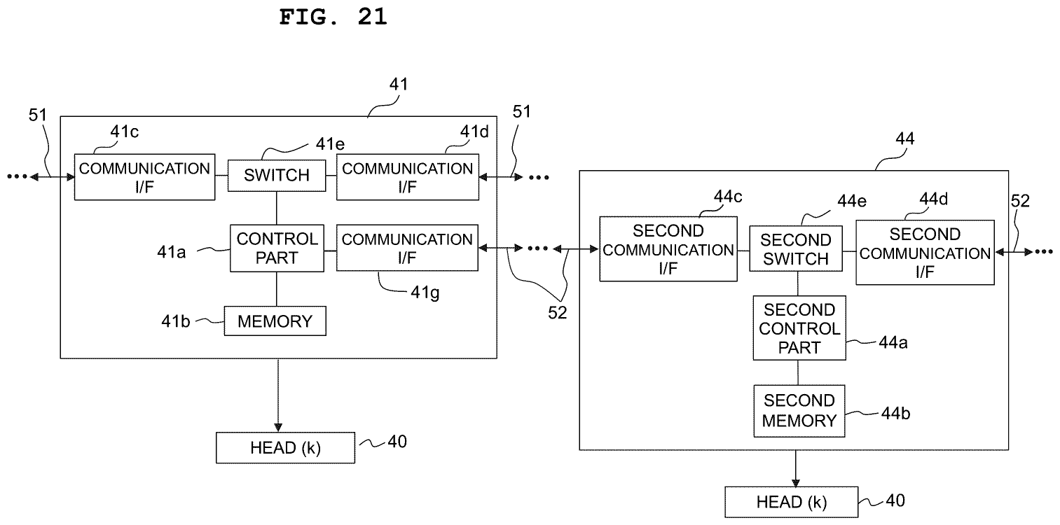

FIG. 21 is a block diagram of the head module 41 and the sub-head module 44 according to the seventh embodiment. The head module 41 according to the seventh embodiment includes a communication I/F 41g. The communication I/F 41g is connected to a control part 41a of the head module 41 and the second communication cable 52.

The sub-head module 44 includes a second control part 44a, a second memory 44b, a second communication I/F 44c, a second communication I/F 44d, and a second switch 44e. The second control part 44a includes, for example, a processor such as a CPU or an MPU, etc. Note that the second control part 44a may include an integrated circuit such as an FPGA or an ASIC, etc. The second memory 44b includes a volatile memory such as an SDRAM, a rewritable and non-volatile storage medium such as an EEPROM, a Flash ROM, a hard disk, etc. Each of the second communication I/F 44c and the second communication I/F 44d is connected to the second communication cable 52.

The second switch 44e is connected to the second communication I/F 44c and the second communication I/F 44d. The second control part 44a is connected to the second switch 44e. The second memory 44b is connected to the second control part 44a. The second switch 44e is switched between a state (first state) in which the second switch 44e connects a second communication cable 52, which is upstream of the sub-head module 44 and which is connected to the sub-head module 44 via the second communication I/F 44c, to the second control part 44a and the second memory 44b, and a state (second state) in which the second switch 44e connects the second communication cable 52 on the upstream side connected to the sub-head module 44 via the second communication I/F 44c to a second communication cable 52 on the downstream side connected to the sub-head module 44 via the second communication I/F 44d.

The switch 41e of the kth head module 41(k) according to the seventh embodiment is switched to the first state in a case where the kth head module 41(k) receives printing data to be processed by the kth head module 41(k), printing data to be processed by the (2k-1)th sub-head module 44(2k-1), or printing data to be processed by the (2k)th sub-head module 44(2k). In a case where the control part 41a of the kth head module 41(k) obtains the printing data, the control part 41a causes the memory 41b to store the obtained printing data and determines whether the obtained printing data is printing data to be processed by which one of the kth head module 41(k), the (2k-1)th sub-head module 44(2k-1) and the (2k)th sub-head module 44(2k). In a case where the obtained printing data is printing data to be processed by the kth head module 41(k), the control part 41a drives the head 40 connected to the kth head module 41(k) based on the printing data. In a case where the obtained printing data is printing data to be processed by either the (2k-1)th sub-head module 44(2k-1) or the (2k)th sub-head module 44(2k), the control part 41a transmits the printing data stored in the memory 41b to the downstream side, via the communication I/F 41g and the second communication cable 52.

The second switch 44e of each of the sub-head modules 44 is switched to the first state in a case where the sub-head module 44 receives printing data to be processed by the sub-head module 44, similarly to the switch 41e of the head module 41; and the second switch 44e is switched to the second state in a case where the sub-head module 44 receives the printing data to be processed by a sub-head module 44 connected to the downstream side of the sub-head module 44. The second control part 44a of each of the sub-head modules 44 switches the second switch 44e to the first state or the second state based on the switch flag or the print position information added to the printing data received by the sub-head module 44. Note that the second switch 44e may include a second switch controlling circuit, and the second switch controlling circuit may switch the second switch 44e to the first state or the second state based on the data amount of the received printing data.

In the head system according to the seventh embodiment, the control part 41a of the kth head module 41(k) obtains the printing data to be processed by the (2k-1)th sub-head module 44(2k-1) or the (2k)th sub-head module 44(2k). The control part 41a of the kth head module 41(k) transmits the printing data to the downstream side, via the second communication cable 52 different from the communication cable 51 connecting the kth head module 41(k) and the (k+1)th head module 41(k+1). With this, during the time since the kth head module 41(k) has transmitted the printing data to the (2k-1)th sub-head module 44(2k-1) or the (2k)th sub-head module 44(2k) and until the (2k-1)th sub-head module 44(2k-1) or the (2k)th sub-head module 44(2k) receives the printing data, for example, each of the head modules 41 can transfer the printing data to the downstream side. This allows the printing data to be efficiently transmitted to the head module 41 or the sub-head module 44 on the downstream side.

### Eighth Embodiment

A head module 41 of a head system according to the eighth embodiment includes a SoC.

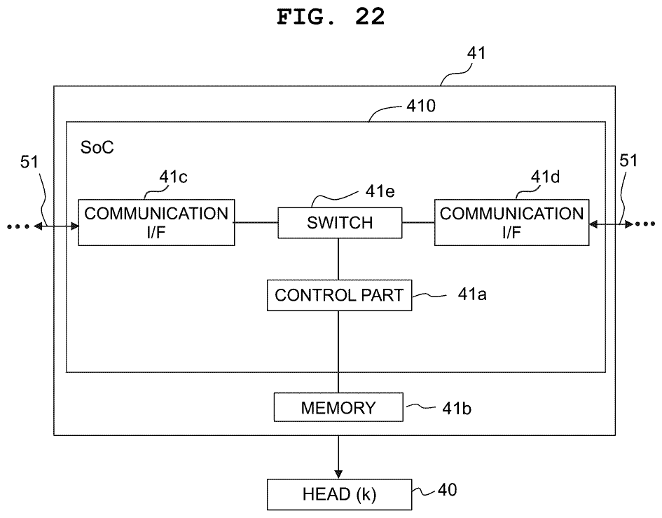

FIG. 22 is a block diagram of the head module 41 according to the eighth embodiment. The head module 41 according to the eighth embodiment includes a SoC 410. A control part 41a, a communication I/F 41c, a communication I/F 41d, and a switch 41e of the head module 41 are mounted on the SoC 410. Note that although a memory 41b according to the eighth embodiment functions as an external memory of the SoC 410, the memory 41b may be mounted on the SoC 410.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A head system comprising:
a controller;
a plurality of heads; and
a plurality of head modules connected to the controller in series via communication cables, the head modules being configured to transfer printing data transmitted by the controller sequentially, wherein
each of the head modules is connected to one of the heads and includes a memory and a switch, the switch being connected to the memory and a downstream communication cable of each of the head modules, the switch being configured to switch destination of connection of an upstream communication cable of each of the head modules,
in a case where one head module included in the head modules receives printing data to be processed by the one head module from an upstream head module which is included in the head modules and is nearer to the controller than the one head module, the switch of the one head module is configured to connect an upstream communication cable of the one head module to the memory of the one head module and disconnect the upstream communication cable of the one head module from a downstream communication cable of the one head module, and
in a case where the one head module receives printing data to be processed by a downstream head module which is included in the head modules and is farther from the controller than the one head module, from the upstream head module, the switch of the one head module is configured to connect the upstream communication cable of the one head module to the downstream communication cable of the one head module and disconnect the upstream communication cable of the one head module from the memory of the one head module.

2. The head system according to claim 1, wherein
in a case where the one head module starts receiving of the printing data, the switch of the one head module is configured to connect the upstream communication cable of the one head module to the memory of the one head module and disconnect the upstream communication cable of the one head module from the downstream communication cable of the one head module, and
in a case where the printing data received by the one head module reaches a predetermined data amount after the one head module has started receiving of the printing data, the switch of the one head module is configured to connect the upstream communication cable of the one head module to the downstream communication cable of the one head module and disconnect the upstream communication cable of the one head module from the memory of the one head module.

3. The head system according to claim 1, wherein
each of the head modules further includes a control part; and
the control part of the one head module is configured to:
determine whether the printing data received by the one head module is the printing data to be processed by the one head module, based on information indicating any one of the head modules and attached to the printing data received by the one head module;
control the switch to connect the upstream communication cable of the one head module to the memory of the one head module and disconnect the upstream communication cable of the one head module from the downstream communication cable of the one head module, in a case where the printing data received by the one head module is the printing data to be processed by the one head module; and
control the switch to connect the upstream communication cable of the one head module to the downstream communication cable of the one head module and disconnect the upstream communication cable of the one head module from the memory of the one head module, in a case where the printing data received by the one head module is not the printing data to be processed by the one head module.

4. The head system according to claim 1, wherein
each of the head modules further includes a control part; and
the control part of the one head module is configured to:
determine whether the printing data received by the one head module is the printing data to be processed by the one head module, based on print position information attached to the printing data received by the one head module and based on position information of the one head module;
control the switch to connect the upstream communication cable of the one head module to the memory of the one head module and disconnect the upstream communication cable of the one head module from the downstream communication cable of the one head module, in a case where the printing data received by the one head module is the printing data to be processed by the one head module; and
control the switch to connect the upstream communication cable of the one head module to the downstream communication cable of the one head module and disconnect the upstream communication cable of the one head module from the memory of the one head module, in a case where the printing data received by the one head module is not the printing data to be processed by the one head module.

5. The head system according to claim 1, wherein
the controller is configured to add an error detecting code to the printing data such that the printing data with the error detecting code is transmitted, and
the switch of the one head module is configured to:
determine whether the printing data received by the one head module contains an error, based on the error detecting code; and
transmit information requesting re-transmission of the printing data to the controller, in a case where the switch of the one head module determines that the printing data received by the one head module contains the error.

6. The head system according to claim 5, wherein
the controller is configured to:
identify the one head module to process the printing data based on the printing data to be transmitted;
obtain a distance between the one head module and the controller; and
determine the number of bits of the error detecting code to be added to the printing data, based on the obtained distance.

7. The head system according to claim 1, further comprising a non-switch head module not including the switch,
wherein at least one of the head modules and the non-switch head module are connected via a second communication cable different from the communication cables.

8. The head system according to claim 1, further comprising a non-memory head module not including the memory,
wherein at least one of the head modules and the non-memory head module are connected via a second communication cable different from the communication cables.

9. The head system according to claim 1, further comprising a sub-head module including a second memory and a second switch,
wherein at least one of the head modules and the sub-head module are connected via a second communication cable different from the communication cables.

10. A head system, comprising:
a controller;
a plurality of heads; and
a plurality of head modules connected in series via communication cables and each connected to a corresponding head of the plurality of heads, the plurality of head modules including:
a head module;
an upstream head module connected to the controller via a communication cable and connected to the head module via an upstream communication cable of the head module, the upstream head module being configured to receive printing data from the controller and transmit the printing data to the head module; and
a downstream head module connected to the head module via a downstream communication cable of the head module and disposed farthest from the controller, the downstream head module being configured to receive the printing data from the head module,
wherein the head module includes a memory and a switch configured to switch destination of connection of an upstream communication cable of the head module,
wherein, when the head module receives the printing data that is to be processed by the head module from the upstream head module, the switch connects the upstream communication cable to the memory, and
wherein, when the head module receives the printing data that is to be processed by the downstream head module from the upstream head module, the switch connects the upstream communication cable to the downstream communication cable.

11. A printer, comprising the head system according to claim 1.
